(19) United States
(12) Patent Application Publication
(10) Pub. No.: US 2025/0244954 A1
(43) Pub. Date: Jul. 31, 2025

(54) METHOD AND APPARATUS WITH POLYNOMIAL MULTIPLICATION OPERATION

(71) Applicants: Samsung Electronics Co., Ltd., Suwon-si (KR); Graz University of Technology, Graz (AT)

(72) Inventors: Sunmin KWON, Suwon-si (KR); Ahmet Can MERT, Graz (AT); Andrey KIM, Suwon-si (KR); Anisha MUKHERJEE, Graz (AT); Aikata AIKATA, Graz (AT); Sujoy SINHA ROY, Graz (AT); Hyungchul KANG, Suwon-si (KR); Maksim DERIABIN, Suwon-si (KR)

(73) Assignees: Samsung Electronics Co., Ltd., Suwon-si (KR); Graz University of Technology, Graz (AT)

(21) Appl. No.: 19/032,696

(22) Filed: Jan. 21, 2025

(30) Foreign Application Priority Data
Jan. 22, 2024 (KR) 10-2024-0009738
May 16, 2024 (KR) 10-2024-0063923

(51) Int. Cl. G06F 7/523; G06F 7/72; G06F 17/14

(52) U.S. Cl. CPC G06F 7/523; G06F 7/722; G06F 7/723; G06F 17/144

(57) ABSTRACT

A processor-implemented method with a polynomial multiplication operation includes obtaining an auxiliary modulus corresponding to moduli according to a Chinese remainder theorem (CRT), performing a number theoretic transform (NTT) operation with respect to the auxiliary modulus on a result of a modulo operation of the moduli for each of a first polynomial and a second polynomial, performing an element-wise multiplication operation between an NTT operation result corresponding to the first polynomial and an NTT operation result corresponding to the second polynomial, and transforming a result of the element-wise multiplication operation into a polynomial corresponding to each of the moduli.

### CROSS-REFERENCE TO RELATED APPLICATIONS

This application claims the benefit under 35 USC § 119 (a) of Korean Patent Application No. 10-2024-0009738, filed on Jan. 22, 2024, and Korean Patent Application No. 10-2024-0063923, filed on May 16, 2024, in the Korean Intellectual Property Office, the entire disclosures of which are incorporated by reference herein for all purposes.

### BACKGROUND

### 1. Field

The following description relates to a method and apparatus with a polynomial multiplication operation.

### 2. Description of Related Art

Cryptographic technology may include post-quantum cryptography (PQC) and related problems and systems. In particular, lattice-based cryptography may be a solution for addressing issues related to PQC. CRYSTALS-Kyber, a lattice-based cryptographic system based on ring learning with errors (RLWE) problems, has been selected for PQC standardization. The unique properties of lattice-based cryptography, particularly RLWE, may be applied to cryptographic algorithms. One example of RLWE is fully homomorphic encryption (FHE). FHE allows for arbitrary computations on ciphertexts without decryption, providing a high level of privacy for external computations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method with a polynomial multiplication operation includes obtaining an auxiliary modulus corresponding to moduli according to a Chinese remainder theorem (CRT), performing a number theoretic transform (NTT) operation with respect to the auxiliary modulus on a result of a modulo operation of the moduli for each of a first polynomial and a second polynomial, performing an element-wise multiplication operation between an NTT operation result corresponding to the first polynomial and an NTT operation result corresponding to the second polynomial, and transforming a result of the element-wise multiplication operation into a polynomial corresponding to each of the moduli.

The obtaining of the auxiliary modulus may include obtaining the auxiliary modulus, which is a Fermat number.

A twiddle factor of an NTT operation with respect to the auxiliary modulus may be determined to be a power of 2.

The performing of the NTT operation with respect to the auxiliary modulus may include transforming the result of the modulo operation of the moduli for each of the first polynomial and the second polynomial into a multivariate polynomial, and performing an NTT operation with respect to the auxiliary modulus on a multivariate polynomial of each of the first polynomial and the second polynomial.

A multivariate polynomial of the first polynomial may include a polynomial in a plurality of variables, and degrees of the plurality of variables may be less than a degree of the first polynomial.

A multivariate polynomial of the second polynomial may include a polynomial in a plurality of variables, and degrees of the plurality of variables may be less than a degree of the second polynomial.

The transforming the result of the element-wise multiplication operation into the polynomial corresponding to each of the moduli may include performing an inverse number theoretic transform (INTT) operation on the result of the element-wise multiplication operation, transforming a result of the INTT operation into a univariate polynomial, and transforming the result of the INTT operation, which is transformed into the univariate polynomial, into a polynomial corresponding to each of the moduli.

The result of the INTT operation may be a multivariate polynomial.

The transforming of the result of the element-wise multiplication operation into the polynomial corresponding to each of the moduli may include performing an inverse number theoretic transform (INTT) operation on the result of the element-wise multiplication operation, and transforming the result of the INTT operation into a polynomial corresponding to each of the moduli.

The obtaining of the auxiliary modulus may include obtaining the auxiliary modulus based on any one or any combination of any two or more of the moduli, a degree of the first polynomial, and a degree of the second polynomial.

The method may include receiving, from a client, an encrypted input, wherein the obtaining of the auxiliary modulus may include obtaining the auxiliary modulus based on the encrypted input, generating an encrypted prediction based on the polynomial corresponding to each of the moduli, and transmitting, to the client, the encrypted prediction.

In one or more general aspects, a non-transitory computer-readable storage medium may store instructions that, when executed by one or more processors, configure the one or more processors to perform any one, any combination, or all of operations and/or methods disclosed herein.

In one or more general aspects, an apparatus with a polynomial multiplication operation includes one or more processors configures to obtain an auxiliary modulus corresponding to moduli according to a Chinese remainder theorem (CRT), perform a number theoretic transform (NTT) operation with respect to the auxiliary modulus on a result of a modulus operation of the moduli for each of a first polynomial and a second polynomial, perform an element-wise multiplication operation between an NTT operation result corresponding to the first polynomial and an NTT operation result corresponding to the second polynomial, and transform a result of the element-wise multiplication operation into a polynomial corresponding to each of the moduli.

The NTT operation may be performed using an NTT operator corresponding to the auxiliary modulus.

For the obtaining of the auxiliary modulus, the one or more processors may be configured to obtain the auxiliary modulus, which is a Fermat number.

A twiddle factor of the NTT operation with respect to the auxiliary modulus may be determined to be a power of 2, and a multiplication operation of the NTT operation may be performed using a bit shifting operation based on the twiddle factor.

For the performing of the NTT operation with respect to the auxiliary modulus, the one or more processors may be configured to transform the result of the modulo operation of the moduli for each of the first polynomial and the second polynomial into a multivariate polynomial, and perform the NTT operation with respect to the auxiliary modulus on a multivariate polynomial of each of the first polynomial and the second polynomial.

A multivariate polynomial of the first polynomial may include a polynomial in a plurality of variables, wherein degrees of the plurality of variables are less than a degree of the first polynomial, and a multivariate polynomial of the second polynomial may include a polynomial in a plurality of variables, wherein degrees of the plurality of variables are less than a degree of the second polynomial.

For the transforming the result of the element-wise multiplication operation into the polynomial corresponding to each of the moduli, the one or more processors may be configured to perform an inverse number theoretic transform (INTT) operation on the result of the element-wise multiplication operation, transform a result of the INTT operation into a univariate polynomial, and transform the result of the INTT operation, which is transformed into the univariate polynomial, into the polynomial corresponding to each of the moduli.

The result of the INTT operation may be a multivariate polynomial.

For the transforming of the result of the element-wise multiplication operation into the polynomial corresponding to each of the moduli, the one or more processors may be configured to perform an inverse number theoretic transform (INTT) operation on the result of the element-wise multiplication operation, and transform a result of the INTT operation into the polynomial corresponding to each of the moduli.

Other features and aspects will be apparent from the following detailed description, the drawings, and the claims.

### BRIEF DESCRIPTION OF THE DRAWINGS

FIG. 1 illustrates an example of a homomorphic encryption (HE) system.

FIG. 2 illustrates an example of an integer polynomial multiplication (IPM) process based on Chinese remainder theorem (CRT).

FIG. 3 illustrates an example of an IPM process based on a number theoretic transform (NTT).

FIG. 4 illustrates an example of an auxiliary modulus mapping process.

FIG. 5 illustrates an example of a multivariate polynomial transformation process.

FIG. 6 illustrates pseudocode for implementing multivariate-NTT (MV-NTT).

FIG. 7 illustrates an example of a polynomial multiplication method.

FIG. 8 illustrates an example of a polynomial multiplication method.

FIG. 9 illustrates an example of a polynomial multiplication method.

FIG. 10 illustrates an example of a configuration of an operation apparatus.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

With regard to the description of the drawings, similar reference numerals may be used to refer to similar or related components. It is to be understood that a singular form of a noun corresponding to an item may include one or more of the things, unless the relevant context clearly indicates otherwise.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the state.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like elements and a repeated description related thereto will be omitted.

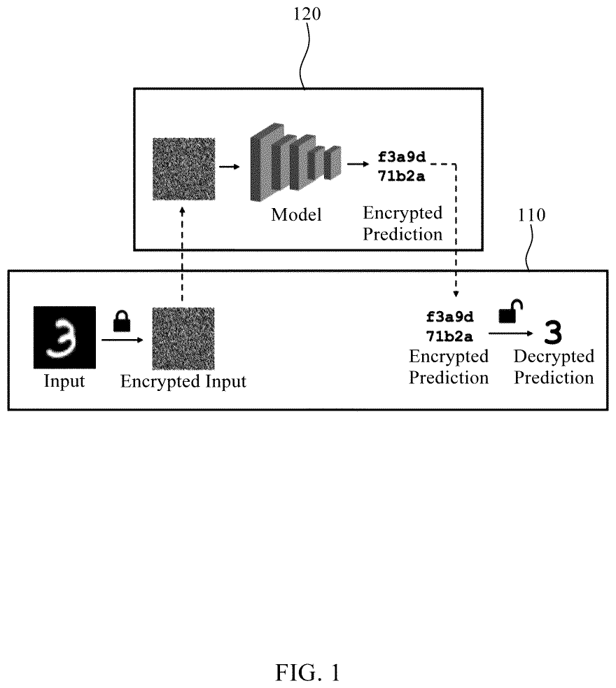

FIG. 1 illustrates an example of a homomorphic encryption (HE) system.

Referring to FIG. 1, the HE system may include a client 110 and a server 120 as agents.

The HE system may be a system in which the server 120 provides an artificial intelligence service to the client 110 without directly exposing data possessed by the client 110 to the server 120.

The client 110 may be an agent receiving the artificial intelligence service from the server 120 and may be referred to as a service using entity, a service user, a data user, and the like. The client 110 may encrypt its own data (e.g., an image) through a client terminal based on an HE technique and transmit the encrypted data to the server 120. The client terminal may be referred to as a user terminal.

HE is an encryption technique for performing an operation on encrypted data without decryption. When various operations are performed on homomorphically encrypted data, the results may be identical to those of the same operations performed on unencrypted data. HE may process data while the data is encrypted, offering a solution to privacy concerns in the data industry.

The server 120 may receive the encrypted data (e.g., an encrypted input) from the client 110 and transmit an artificial intelligence operation result corresponding to the encrypted data (e.g., an encrypted prediction) to the client 110. For example, the server 120 may receive, from the client 110, the encrypted input, generate the encrypted prediction based on a polynomial corresponding to each of moduli, and transmit, to the client 110, the encrypted prediction. The server 120 may be referred to as a service provider, a service providing entity, and the like.

The server 120 may provide various artificial intelligence services to the client 110. For example, the server 120 may provide the client 110 with a service such as face recognition and/or mask detection, where maintaining the confidentiality of user data is crucial. However, an operation for providing an artificial intelligence service may use a large amount of memory and extensive network data transmission. For example, when encrypting data for convolutional neural network inference, numerous homomorphic ciphertexts may be generated, demanding a large amount of memory and extensive network data transmission.

In a lattice-based cryptographic system, such as ring learning with errors (RLWE) of post-quantum cryptography (PQC), one of the operationally intensive tasks is integer polynomial multiplication (IPM), which may be referred to as ring multiplication. A naïve algorithm for IPM, such as a textbook operation, may have quadratic complexity.

The naïve algorithm for IPM may be expressed by Equation 1 below, for example.

$$c = ( {\sum }_{i = 0}^{n} {a}_{i} {X}^{i} ) \cdot ( {\sum }_{j = 0}^{m} {b}_{j} {X}^{j} ) = {\sum }_{k = 0}^{n + m} ( {\sum }_{i + j = k} {a}_{i} {b}_{i} ) \cdot {X}^{k} \qquad Equation 1$$

An operation method of Equation 1 increases the amount of operations when processing a polynomial with large coefficients and high degrees. Simple multiplication of individual terms may involve significant computational overhead, making it inefficient for multiplying polynomials with large coefficients or high degrees.

A number theoretic transform (NTT) operation may provide a practical method of performing polynomial multiplication over a ring of integers at significantly lower cost. The NTT operation may allow a polynomial multiplication process to be replaced with component-wise or element-wise multiplication. An element-wise multiplication operation may be less computationally intensive, allowing a multiplication problem to be efficiently transformed into an addition problem under a predetermined condition. This, in turn, simplifies the overall calculation process and improves the speed and efficiency of a task. Therefore, hardware for efficient NTT operations may be important for hardware accelerators for lattice-based and PQC systems.

To optimize the performance of hardware for NTT operations and utilize parallelism, a fully homomorphic encryption (FHE) system may often rely on the Chinese remainder theorem (CRT), utilizing the computational advantages of a residue number system (RNS) derived from the CRT. The CRT may divide large numbers into a series of smaller numbers, enabling independent and parallel operations, which may significantly reduce the computational complexity of operations using the CRT.

The CRT and an NTT may be used as the basis for an IPM algorithm. A polynomial multiplication method of one or more embodiments described below is an algorithm that may be based on the CRT and NTT and may be a method that may improve the efficiency of hardware for polynomial multiplication. According to an example, the polynomial multiplication method may include at least one of an auxiliary modulus mapping process and a multivariate polynomial transformation process.

The auxiliary modulus mapping process may involve mapping back and forth between an auxiliary modulus and another CRT modulus. An NTT operation may be performed on an auxiliary modulus instead of a plurality of CRT moduli, and hardware that performs an NTT operation on the auxiliary modulus may be used for polynomial multiplication. This approach of one or more embodiments may facilitate the selection of the modulus and NTT operation most suitable for the hardware, while also providing a universal solution that does not depend on a predetermined parameter of a given cryptographic system.

For any natural number n, a Fermat number, defined as 2²ⁿ+1, may be determined as the auxiliary modulus. Due to the unique properties of Fermat numbers, twiddle factors for low-degree NTT operations below Fermat numbers may be powers of 2. As a result, these twiddle factors may not need to be stored separately in hardware. Additionally, a modulo multiplication operation in an NTT operation process may be replaced with modulo shifting. Through this replacement, the method and apparatus of one or more embodiments may improve the speed and efficiency of hardware acceleration.

Performing a modulo operation using Fermat numbers may lead to complexity in operations, as larger Fermat numbers may need to be selected for polynomials of higher degrees. Accordingly, a multivariate polynomial transformation process may be performed.

The multivariate polynomial transformation process may involve transforming the original polynomial, which has a univariate polynomial structure, into a multivariate structure. The multivariate polynomial transformation process may address the challenge of hardware acceleration becoming difficult in NTT operations related to polynomials of higher degrees. The multivariate polynomial transformation process of one or more embodiments may enhance hardware acceleration for polynomial multiplication by utilizing reusable NTT operators for lower degrees, thereby improving parallelization of operations. The use of multivariate polynomials of one or more embodiments may overcome the limitations imposed by higher-degree polynomials when a Fermat number is used as an auxiliary modulus.

Hereinafter, the ring of a polynomial for a single variable may be represented as R[X], and the multivariate ring for multiple variables X₁, . . . ,Xₖ may be represented as R [X₁, . . . ,Xₖ]. For N∈ [symbol] , N is a power of 2. For the number field [symbol] [X]/(ϕ_{2N}(x)), [symbol] = [symbol] [x]/(ϕ_{2N}(x)) may be defined as the ring of integers including modulo of polynomials for the 2N-th cyclotomic polynomial ϕ_{2N}(x)= [symbol] +1. R_{q}=R/qR is the remainder ring of R modulo integer q. The element of R_{q} may be a polynomial in the form of a(X)=Σᵢ₌ₐ^{N-1}aᵢxⁱ, where each coefficient aᵢ may belong to Z_{q}. In the case of multiple variables, the same notation is used, with X replaced by Xᵢ. Hereinafter, [symbol] may be represented as Z. When q E Z and q>1, the ring Z_{q} may be a set of integers modulo q, where [−q/2, q/2) may be a representative interval of the ring Z_{q}. For x∈Z, the centered remainder of the operation (x modulo q) may be represented as [x]]_{q}∈Z_{q}. The centered remainder may refer to the remainder of dividing x by q, adjusted to fall within the range of −q/2 or more and less than q/2. This notation may be extended by being applied to each coefficient of the terms of R_{q}.

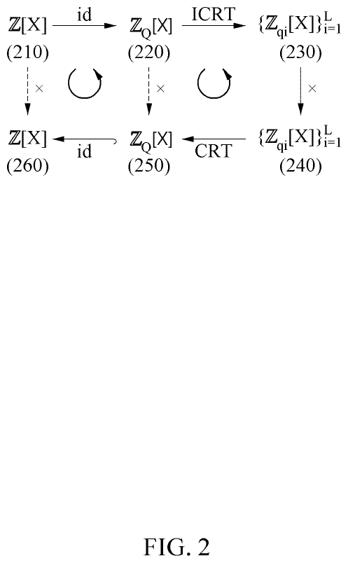

FIG. 2 illustrates an example of an IPM process based on the CRT.

An RNS may use the CRT to represent an integer as a vector transformed into the bases of integers that are co-prime of the remainder modulo a. This approach may also be applied to polynomials in rings. When a is a polynomial in R_{Q} and C={q0, . . . , qₖ₋₁} is the base of Q=Πᵢ₌₁^{k-1} qᵢ, the ring isomorphism from a ∈R_{Q} to (a⁽⁰⁾, a⁽¹⁾, . . . , a^{(k-1)} ΣΠᵢ₌₀^{k-1} [symbol] _{q}: may be applied coefficient-wise. The RNS may be frequently used alongside NTT in implementing an HE system on both hardware and software platforms, as the RNS facilitates parallelization of computations.

Referring to FIG. 2, a polynomial in a ring Z [X] 210 may be transformed into a polynomial in a ring Z_{Q}[X] 220 through a modulo operation with respect to Q.

Using the CRT, the polynomial in the ring Z_{Q}[X] 220 may be mapped to the polynomial in a ring Z_{qi} [X] 230 with respect to the modulo of the integer qᵢ for each i. This process may involve dividing a polynomial into smaller polynomials that may be handled more easily. A multiplication operation may be performed in the small ring Z_{qi} [X] 230 modulo qᵢ. Therefore, IPM based on the CRT may provide a more manageable and efficient approach to IPM by dividing a larger problem into a series of smaller problems.

In the case of IPM based on the CRT, a value that satisfies a predetermined criteria may be selected as the composite number Q. For example, when IPM is a multiplication operation between polynomial a and polynomial b, Q may be determined to be a value greater than the product of the maximum coefficient of the polynomial a, the maximum coefficient of the polynomial b, and the maximum degree of the two polynomials. In other words, when aᵢ represents the coefficient of the polynomial a, bᵢ represents the coefficient of the polynomial b, n represents the degree of the polynomial a, and m represents the degree of the polynomial b, Q may be determined to be a value that satisfies the condition Q>max (aᵢ)·max (bᵢ)·max (n+1, m+1). This condition may ensure that an operation does not result in overflow.

Each of the polynomials a and b may be mapped from the ring Z [X] 210 to the ring Z_{Q} [X] 220 using an identity map. This mapping essentially transforms a polynomial into another ring, enabling a more efficient multiplication operation. A multiplication result 240 using the CRT may be mapped to a ring Z_{Q} [X] 250 through an inverse CRT (ICRT) operation and may be transformed back to an original ring Z [X] 260 using the identity map.

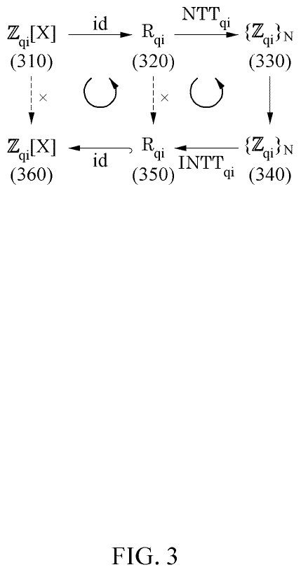

FIG. 3 illustrates an example of an IPM process based on an NTT.

An NTT is an extension of the Fourier transform on finite fields, and polynomial multiplication may be replaced by element-wise multiplication through the NTT. The NTT may be used in an IPM operation in combination with the CRT. For example, when IPM is a multiplication operation between polynomial a and polynomial b, n represents the degree of the polynomial a, and m represents the degree of the polynomial b, an integer N greater than n+m and a power of 2 may be selected. The condition of N may serve as a condition to prevent overflow. In the context of being NTT-friendly, a number that leaves a remainder of 1 when divided by 2N may be selected as each prime number qᵢ, that is, qᵢ may be expressed as qᵢ=1 (mod 2N). The polynomial ring modulo (X^{N}+1) may be expressed as R=Z [X]/(X^{N}+1).

Referring to FIG. 3, an IPM process based on the NTT may be described as follows. A polynomial in a ring Z_{qi} [X] 310 may be transformed or elevated to a ring R_{qi} 320. Then, by an NTT operation the ring R_{qi} 320 may be transformed into the set of integers Z_{qi} 330 of modulo qᵢ. The multiplication operation may be performed as an element-wise multiplication operation in the set of integers Z_{qi} 330 of each modulo qᵢ of different polynomials. A multiplication result 340 may be reverted to a ring R_{qi} 350 using an inverse NTT (INTT). The ring R_{qi} 350 may be further elevated and transformed into a ring Z_{qi} [X] 360. The transformation to the ring Z_{qi} [X] 360 may be possible due to the condition of no overflow.

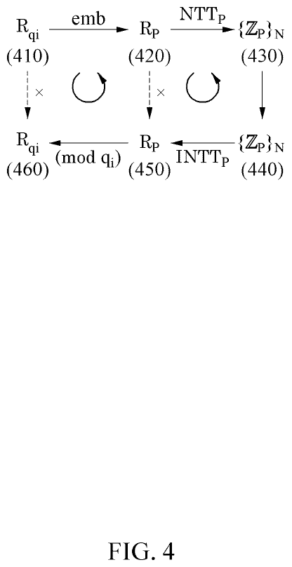

FIG. 4 illustrates an example of an auxiliary modulus mapping process.

Referring to FIG. 4, an auxiliary modulus mapping process may involve transforming moduli qᵢ into an auxiliary modulus P according to the CRT, performing a modulo P operation, and then reverting the auxiliary modulus P to qᵢ. Instead of being implemented to process an NTT for different qᵢ, hardware may be implemented to process an NTT for a single modulus P. By optimizing the structure of the hardware to process computations for a single modulus, the method and apparatus of one or more embodiments may optimize hardware resources and improve multiplication processing speed in a ring R_{qi} 410.

After the ring R_{qi} 410 is transformed into a ring Rp 420, multiplication may be performed in Rp 420 and the ring Rp 420 may be reverted to the ring R_{qi} 460. For the accurate determination of polynomial multiplication, P may be sufficiently large to prevent modulo reduction by P. When the initial coefficient of a polynomial is less than q/2 and the degree is N, the coefficient of a product in the ring R may be less than q²/4. By selecting an auxiliary modulus P to be P>q²/4×N, it may be ensured that the multiplication in the ring R matches the multiplication in the ring Rp 420. When P is selected such that P=1 (mod 2N), multiplication in the ring Rp 420 may be performed using NTT optimization with respect to the modulus P. Therefore, instead of performing multiplication on modulo q, it may be possible to perform polynomial multiplication with respect to the auxiliary modulus P, return to q, and perform modulo q reduction. More particularly, by an NTT operation, the ring Rₚ 420 may be transformed into the set of integers Zₚ 430 of P modulo. The multiplication operation may be performed as an element-wise multiplication operation of the set of integers Zₚ 430 of P modulo of different polynomials. A multiplication result 440 may be reverted to a ring Rₚ 450 using the INTT. The ring Rₚ 450 may be transformed into a ring R_{qi} 460 by a modulo operation.

By using the Fermat number: [symbol] =2^{K}+1 (where, K is a power of 2) as an auxiliary modulus, the method and apparatus of one or more embodiments may improve hardware acceleration and compatibility of multiplication operations. Due to a simple binary structure, reduction of FK modulo may be performed efficiently. Another advantage of using the Fermat number Fₖ is that the 2K-th root of unity of Fₖ modulo is 2, and therefore when NÂK, the twiddle factor used in an NTT is a power of 2. As a result, all multiplication operations of an NTT operation may be replaced by bit shift operations of FK modulo.

The limitation of IPM using a Fermat number as an auxiliary modulus is that an NTT operation with a twiddle factor that is a power of 2 only works for N≤K. When the auxiliary modulus is determined to be F₁₂₈=2¹²⁸⁺¹, polynomial multiplication may be performed using an NTT for dimension less than 128. In other words, the maximum possible dimension for an NTT is 128. However, in an RLWE-based FHE scheme, the size of a polynomial is generally much larger, often reaching up to N=2¹⁶. Therefore, a large Fermat number F_{2\hat{ }16} with 65,537 bits may need to be adopted as an auxiliary modulus for an NTT. When moduli qᵢ are 54 bits, the size of a coefficient may increase by 1214 times.

Hereinafter, an NTT using a Fermat number may be referred to as a Fermat NTT (FNTT).

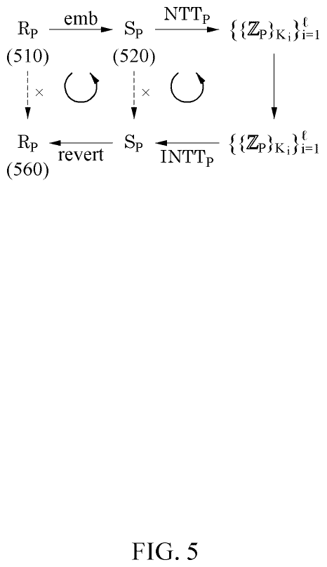

FIG. 5 illustrates an example of a multivariate polynomial transformation process.

When N is greater than K, the constraints of an FNTT may exist. Accordingly, a new polynomial multiplication method of one or more embodiments may overcome the constraints of an FNTT. To leverage the benefits of small values of FK, a multivariate residue ring may be used.

Referring to FIG. 5, a ring Rₚ= [symbol] ₚ [X]/(X^{N}+1) 510 of a single polynomial structure may be transformed into a ring [symbol] ₚ=ₚ[X₁, . . . , Xₖ]/(X₁^{N}^{₁}+1, . . . ,Xₖ^{N}^{ₖ}+1) 520 of a multivariate polynomial structure for Nᵢ|K, where calculations may be performed in the ring Sₚ 520, and the ring Rₚ may be reverted to a ring Rₚ 560. This approach may reduce the dimensionality of an NTT but come with the trade-off of increasing the number of NTTs. By transforming the original polynomial into a multivariate polynomial, NTT operations may be performed in parallel. Through a reduction in block size, the method and apparatus of one or more embodiments may improve hardware construction to be more efficient and manageable, thereby contributing to overall performance enhancement.

For example, by setting X₁=X and introducing a new variable X₂=X₁^{K/2}, the univariate ring Rₚ=Zₚ [X]/(X^{N}+1) may be embedded into the bivariate ring Zₚ [X₁, X₂]/(X₂^{2N/K}+1). After performing multiplication in Zₚ [X₁, X₂]/(X₂^{2N/K}+1), X₂ may be transformed into X₁^{K/2} and then reverted to Zₚ [X]/(X^{N}+1). This constraint (overflow condition) ensures that all powers of X₁ after embedding are less than K/2, thereby allowing X₂=X₁^{K/2} to be set. In other words, the univariate polynomial a (X)=a₀+a₁X+ . . . +a_{N}X^{N} ∈Rₚ may be transformed into the bivariate polynomial a′ (X₁, X₂)=a₀+a₁X₁+ . . . +a_{(K/2-1)} X₁^{(K/2-1)}+a_{(K/2)} X₂+a_{(K/2+1)} X₂²+a_{(2N/K)} X₂^{(2N/K)}. As a result, since all powers of X₁ after multiplication are less than K, the multiplication in the ring Zₚ [X₁, X₂]/(X₂^{(2N/K)}+1) may imitate polynomial multiplication in the ring Zₚ [X₁, X₂]/(X₁^{K}+1, X₂^{(2N/K)}+1). Polynomial multiplication in the ring Zₚ [X₁, X₂]/(X₁^{K}+1, X₂^{(2N/K)}+1) may be efficiently achieved using an FNTT for dimensions of K and 2N/K. When 2N/K>K, a third variable X₃=X₂^{(K/2)} may be introduced and the ring Rₚ=Zₚ [X]/(X^{N}+1) may be embedded into Zₚ [X₁, X₂, X₃] (X₃^{(4N/K2)}+1). Applying the same logic again, multiplication in the ring Zₚ [X₁, X₂, X₃]/(X₃^{(4N/K2)}+1) may align with multiplication in the ring R=Zₚ [X]/(X^{N}+1), and the dimensionality of an FNTT may become K and 4N/K². By repeatedly applying this trick, the multiplication of a univariate polynomial in the ring R=Z_{P} [X]/(X^{N}+1) may be replaced by the multiplication in the ring [symbol] = [symbol] ₚ[X₁, . . . , Xₖ]/X₁^{N}^{₁}+1, . . . , Xₖ^{N}^{ₖ}+1). Here, for Nᵢ|K, X₁=X,Xᵢ₊₁=X^{N}^{ᵢ}^{/2} may be set.

The term “multivariate-NTT (MV-NTT)” may be used to refer to an NTT operation in a multivariate setting. Each small-dimensional NTT performed in an MV-NTT is an FNTT, which uses Fermat numbers.

By dividing the univariate polynomial ring into a multivariate ring, the dimensionality of an FNTT may be reduced, allowing efficient utilization of Fermat numbers in NTT calculations. These small-dimensional FNTTs may be determined in parallel. Additionally, since each small FNTT of the same size possesses the same structure, an unified, fast, and tailored circuit may be designed for all small FNTTs. Additionally, a small NTT dimension may reduce the size difference between the auxiliary modulus FK and the original RNS modulus q, thus reducing the overall area overhead introduced by the auxiliary modulus.

While the dimensionality of the FNTT is reduced, the number of FNTTs that need to be performed for each polynomial may be increased. For example, with the introduction of each new variable, the overall dimension (i.e., the total number of FNTTs) may double, increasing the amount of computations, memory, and bandwidth requirements. The increased amount of computations may have to be addressed by utilizing a cost-effective arithmetic unit enabled by shift-based modular multiplication of an FNTT.

In a multidimensional polynomial method, with the addition of each new variable, the total dimension may double, but advantages such as parallelism, reduced NTT block size, and optimized hardware design may effectively offset this complexity. Additionally, a multivariate technique may be well combined with an auxiliary modulus technique.

A Fermat number modulo operation (or arithmetic operation) may include addition, multiplication, modulo reduction, and multiplication (shifting) by a twiddle factor.

For example, a modulo reduction algorithm for q=2^{2k}+1 may be an algorithm of a reduction operation using the 2^{2k}=−1 relationship. For two integers x,y∈[0, q−1], the product xy may be at most

$${x}_{m ax} \cdot {y}_{ma x} = {2}^{{2}^{K}} \cdot {2}^{{2}^{K}} = {2}^{{2}^{K} + 1} .$$

Similarly, NTT/INTT operations may require integers x∈[0, q−1] shifted to the left by up to 2K, and thus, integers up to

$${x}_{ma x} ≪ {2}^{K} = {2}^{{2}^{K} + 1}$$

may be generated. Therefore, the proposed modulo reduction algorithm assumes that an input integer falls within the range [0,2^{K+1}]. To ensure a positive integer result after a reduction operation, only one addition with q may be required.

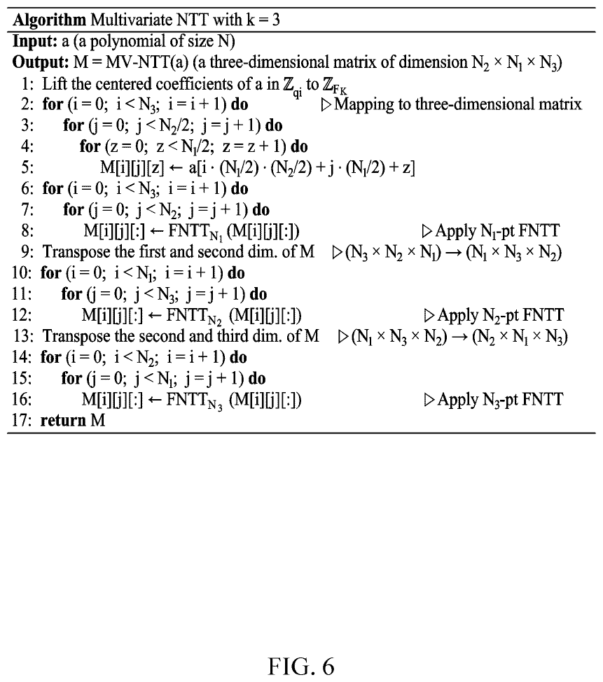

FIG. 6 illustrates pseudocode for implementing an MV-NTT.

FIG. 6 illustrates an algorithm of an MV-NTT operation with k=3, which includes three stages of sizes N₁, N₂, and N₃. A transpose operation may be performed between each FNTT stage. M may represent a three-dimensional structure with vertical planes of N₃. M [i] [j] [:] may represent the j-th row of the i-th plane of M. Each small-dimensional NTT operation may be performed with FNTTs (FNTT_{N1}, FNTT_{N2}, and FNTT_{N3}) using Fermat number F_{K}=2^{K}+1.

An inverse MV-NTT operation may be performed in the reverse order. That is, the inverse MV-NTT operation may begin with an N₃-point inverse FNTT (IFNTT) and conclude by lifting centered coefficients from Zₚₖ to Zₖᵢ.

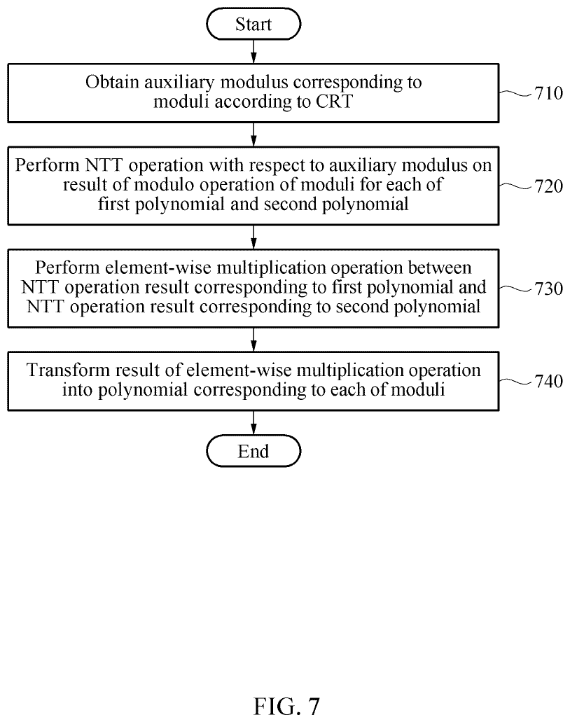

FIG. 7 illustrates an example of a polynomial multiplication method.

The polynomial multiplication method may correspond to the polynomial multiplication method including the auxiliary modulus mapping process described above. The polynomial multiplication method may be performed by an operation apparatus for a polynomial multiplication operation. The hardware configuration of the operation apparatus is described in detail below.

Referring to FIG. 7, the polynomial multiplication method may include operation 710 of obtaining an auxiliary modulus corresponding to moduli according to the CRT. For example, the auxiliary modulus may be determined as a preset value or may be determined as a value corresponding to a preset condition. The auxiliary modulus may be stored in a memory of the operation apparatus that performs the polynomial multiplication method or a memory accessible from the operation apparatus or may be input into the operation apparatus. The operation apparatus may obtain the auxiliary modulus by reading the auxiliary modulus stored in the memory or receiving the input auxiliary modulus.

Operation 710 of obtaining the auxiliary modulus may include obtaining the auxiliary modulus based on at least one of moduli, the degree of a first polynomial, and the degree of a second polynomial. As described above, when the initial coefficient of a polynomial is less than q/2 and the degree of the polynomial is N, the auxiliary modulus P may be determined as P>q²/4×N.

Operation 710 of obtaining the auxiliary modulus may include obtaining an auxiliary modulus, which is a Fermat number. The auxiliary modulus may be determined as a Fermat number. As described above, when the auxiliary modulus is determined as a Fermat number, the twiddle factor of an NTT operation with respect to the auxiliary modulus may be determined as a power of 2.

The polynomial multiplication method may include operation 720 of performing an NTT operation with respect to the auxiliary modulus on the results of the modulo operation of the moduli for each of the first polynomial and the second polynomial. For example, when there are k moduli according to the CRT, the result of the modulo operation of the moduli for the first polynomial may include k modulo operation results of the k moduli for the first polynomial. For example, the result of the modulo operation of the modulus qᵢ for the polynomial A (X) may include a remainder or a central remainder after dividing each coefficient of the polynomial A (X) by qᵢ.

When the auxiliary modulus is determined as a Fermat number, the twiddle factor of the NTT operation with respect to the auxiliary modulus may be determined as a power of 2, and all multiplication operations of the NTT operation may be replaced by a bit shift operation of the Fₖ modulo.

Operation 720 of performing the NTT operation with respect to the auxiliary modulus may include transforming the result of the modulo operation of the moduli for each of the first polynomial and the second polynomial into a multivariate polynomial and performing the NTT operation with respect to the auxiliary modulus on a multivariate polynomial of each of the first polynomial and the second polynomial. In other words, the polynomial multiplication method may include the multivariate polynomial transformation process described above. The polynomial multiplication method including the multivariate polynomial transformation process is described in detail below.

The polynomial multiplication method may include operation 730 of performing an element-wise multiplication operation between an NTT operation result corresponding to the first polynomial and an NTT operation result corresponding to the second polynomial.

The polynomial multiplication method may include operation 740 of transforming the result of the element-wise multiplication operation into a polynomial corresponding to each of the moduli.

Operation 740 of transforming the result of the element-wise multiplication operation into a polynomial corresponding to each of the moduli may include performing an INTT operation for the result of the element-wise multiplication and transforming the result of the INTT operation into a polynomial corresponding to each of the moduli.

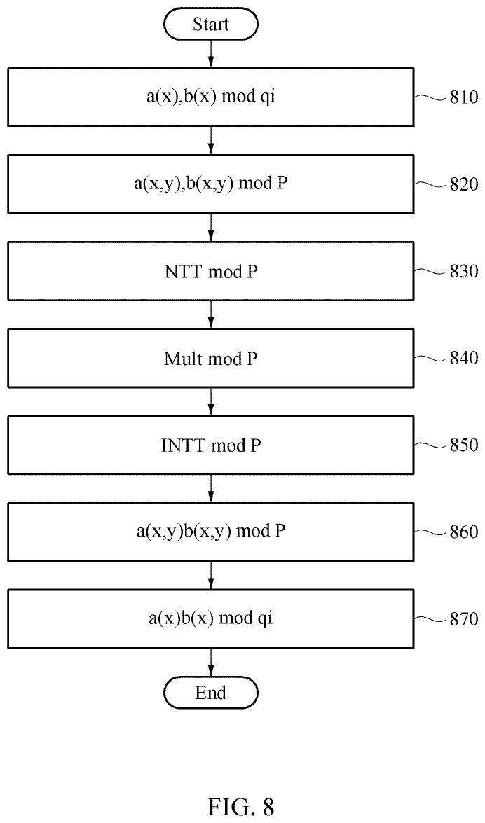

FIG. 8 illustrates an example of a polynomial multiplication method.

The polynomial multiplication method may correspond to the polynomial multiplication method including the auxiliary modulus mapping process and the multivariate polynomial transformation process described above.

Referring to FIG. 8, operation 810 may correspond to performing a modulo operation of the modulus qᵢ for each of the first polynomial a(x) and the second polynomial b(x). A modulo operation for each of a plurality of moduli q₁, q₂, . . . , qₖ according to the CRT may be performed on a polynomial.

Operation 820 may correspond to transforming the moduli q₁, q₂, . . . , qₖ into the auxiliary modulus P and transforming the results of the modulo operations of the moduli q₁, q₂, . . . , qₖ for each of the first polynomial and the second polynomial into a multivariate polynomial. For example, the multivariate polynomial of the first polynomial may include a polynomial in a plurality of variables, wherein the degrees of the plurality of variables are less than the degree of the first polynomial. For example, the multivariate polynomial of the second polynomial may include a polynomial in a plurality of variables, wherein the degrees of the plurality of variables are less than the degree of the second polynomial. As described above, operation 820 may correspond to an operation of transforming Z [X]/(X^{N}+1) into Z [X, Y]/(X^{K}+1, Y^{2N/K}+1) by introducing a new variable Y=X^{K/2} to the polynomial Z [X]/(X^{N}+1) with a single polynomial structure.

The polynomial multiplication method may include operation 830 of performing an NTT operation with respect to the auxiliary modulus P on a multivariate polynomial of each of the first polynomial and the second polynomial and operation 840 of performing an element-wise multiplication operation between an NTT operation result corresponding to the first polynomial and an NTT operation result corresponding to the second polynomial.

The polynomial multiplication method may include operation 850 of performing an INTT operation on the result of the element-wise multiplication operation and operation 860 of transforming an INTT operation result corresponding to a multivariate polynomial into a univariate polynomial. For example, Z [X, Y] may be reverted to Z [X] by substituting Y=X^{K/2}.

The polynomial multiplication method may include operation 870 of transforming a polynomial corresponding to the modulo P transformed into a single variable into a polynomial corresponding to each of the moduli.

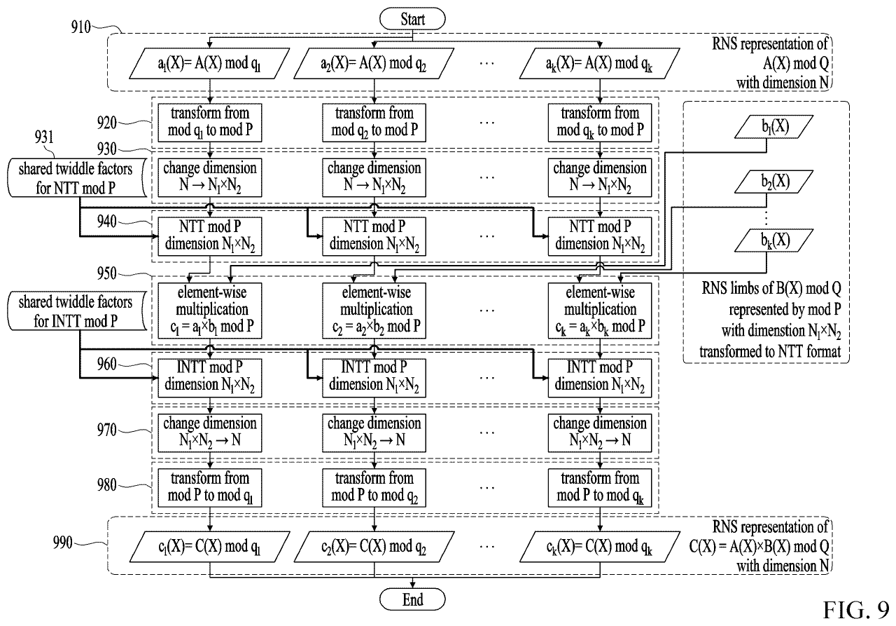

FIG. 9 illustrates an example of a polynomial multiplication method.

Referring to FIG. 9, the process of multiplying A (X) by B (X) is illustrated, and moduli according to the CRT may include q₁, q₂, . . . , qₖ.

The polynomial multiplication method may include operation 910 of obtaining modulo operation results a₁ (X), a₂ (X), . . . , aₖ (X) of the moduli q₁, q₂, . . . , qₖ for the polynomial A(X). For example, a₁ (X), a₂ (X), . . . , aₖ (X) may include a remainder or a central remainder obtained by dividing each coefficient of the polynomial A (X) by the modulus qᵢ. Also, for the polynomial B(X), the modulo operation results b₁ (X), b₂ (X), . . . , bₖ (X) of the moduli q₁, q₂, . . . , qₖ may be obtained.

The moduli according to the CRT may be determined as the auxiliary modulus P corresponding to q₁, q₂, . . . , qₖ. The polynomial multiplication method may include operation 920 of transforming the moduli q₁, q₂, . . . , qₖ into the auxiliary modulus P. An NTT operation with respect to the auxiliary modulus P may be performed.

The polynomial multiplication method may include operation 930 of transforming a polynomial with a single polynomial structure into a multivariate polynomial structure. The polynomial with a single polynomial structure may include the results of modulo operations of the moduli q₁, q₂, . . . , qₖ for the polynomial A(X) and the results of modulo operations of the moduli q₁, q₂, . . . , qₖ for the polynomial B(X). For example, an N-dimensional polynomial for a single variable may be transformed into the multiplication between an N₁-dimensional polynomial for a first variable and an N₂-dimensional polynomial for a second variable. N₁ and N₂ may be determined to be smaller than N. For example, when the result of the NTT operation with respect to the auxiliary modulus P of a single polynomial structure is Z [X]/(X^{N}+1), the result of the NTT operation may be transformed into a multivariate polynomial structure Z [X, Y]/(X^{K}+1, Y^{2N/K}+1).

The polynomial multiplication method may include operation 940 of performing the NTT operation with respect to the auxiliary modulus P on the multivariate polynomial obtained as a result of operation 930. The same twiddle factor 931 for the NTT operation with respect to the auxiliary modulus P may be used for a plurality of multivariate polynomials derived from the results of the modulo operations of the moduli q₁, q₂, . . . , qₖ. As described above, when the auxiliary modulus is a Fermat number, the twiddle factor may be determined as a power of 2, and a multiplication operation using the twiddle factor may be replaced with a bit shifting operation.

The polynomial multiplication method may include operation 950 of performing element-wise multiplication of an NTT operation result. An element-wise multiplication operation may be performed between an NTT operation result corresponding to the polynomial A (X), which is transformed into a multivariate polynomial structure, and an NTT operation result corresponding to the polynomial B (X).

The polynomial multiplication method may include operation 960 of performing an INTT operation on the result of the element-wise multiplication operation and operation 970 of transforming an INTT operation result corresponding to a multivariate polynomial into a univariate polynomial. For example, Z [X, Y] may be reverted to Z [X] by substituting Y=X^{K/2}.

The polynomial multiplication method may include operation 980 of transforming a result, which is transformed into a univariate polynomial, into a polynomial corresponding to each of the moduli q₁, q², . . . , qₖ.

The polynomial multiplication method may include operation 990 of obtaining of modulo operation results C₁ (X), C₂ (X), . . . , Ck (X) of the moduli 1, 92, . . . , qₖ of a polynomial C (X), which is the product of A (X) and B (X).

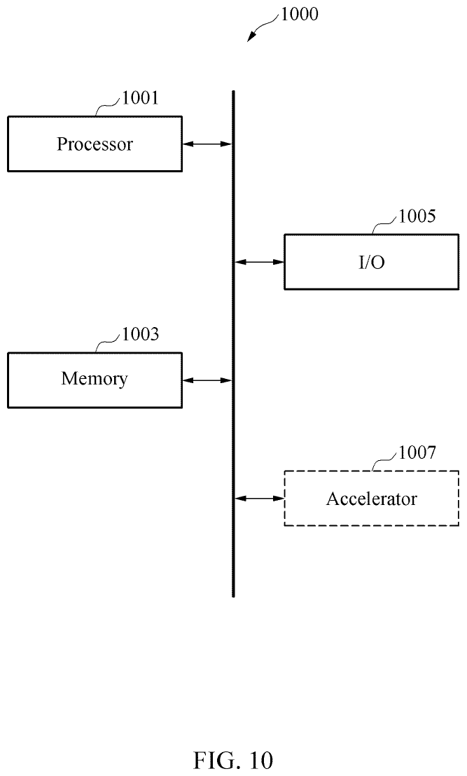

The polynomial multiplication method may be used for more purposes than IPM. For example, the polynomial multiplication method may be effectively used for the ring Z [X]/(X^{N}+1) multiplication, a type of determination that frequently occurs in lattice cryptography applications. In particular, these techniques may help optimize operations within the RLWE system, which is the basis for various cryptographic systems, including Brakerski, Gentry, and. Vaikuntanathan (BGV), Brakerski, Fan, and Vercauteren (BFV), and Cheon, Kim, Kim and Song (CKKS). The polynomial multiplication method may facilitate hardware acceleration for an encryption system. FIG. 10 illustrates an example of a configuration of an operation apparatus.

Referring to FIG. 10, an operation apparatus 1000 may include a processor 1001 (e.g., one or more processors), a memory 1003 (e.g., one or more memories), and an input/output (I/O) device 1005 (e.g., one or more I/O devices). The operation apparatus 1000 is an apparatus for a polynomial multiplication operation and may include an apparatus for performing the polynomial multiplication method described above with reference to FIGS. 1 to 9.

The processor 1001 may perform at least one operation of the polynomial multiplication method described above with reference to FIGS. 1 to 9. For example, the processor 1001 may perform at least one of an operation of obtaining an auxiliary modulus corresponding to moduli according to the CRT, an operation of performing an NTT operation with respect to the auxiliary modulus on a result of a modulo operation of the moduli for each of a first polynomial and a second polynomial, an operation of performing an element-wise multiplication operation between an NTT operation result corresponding to the first polynomial and an NTT operation result corresponding to the second polynomial, and an operation of transforming a result of the element-wise multiplication operation into a polynomial corresponding to each of the moduli.

The NTT operation may be performed using an NTT operator corresponding to the auxiliary modulus.

The operation apparatus 1000 may include an accelerator 1007. The accelerator 1007 may be a hardware device that processes an HE operation. At least one operation of the polynomial multiplication method described above with reference to FIGS. 1 to 9 may be performed by the accelerator 1007. For example, the accelerator 1007 may include an NTT operator corresponding to the auxiliary modulus.

The memory 1003 may be a volatile or non-volatile memory and may store data related to the polynomial multiplication method described above with reference to FIGS. 1 to 9. For example, the memory 1003 may store data generated during the process of performing the polynomial multiplication method or data required to perform the polynomial multiplication method. For example, the memory 1003 may store the auxiliary modulus. For example, the memory 1003 may store a twiddle factor.

The memory 1003 may not be a component of the operation apparatus 1000 and may be included in an external device accessible by the operation apparatus 1000. In this case, the operation apparatus 1000 may receive data stored in the memory 1003 included in the external device and transmit data to be stored in the memory 1003 through a communication module and the like.

The memory 1003 may store a program configured to implement the polynomial multiplication method described above with reference to FIGS. 1 to 9. The processor 1001 may execute the program stored in the memory 1003 and control the apparatus 1000. Code of the program executed by the processor 1001 may be stored in the memory 1003. For example, the memory 1003 may include a non-transitory computer-readable storage medium storing instructions that, when executed by the processor 1001, configure the processor 1001 to perform any one, any combination, or all of the operations and/or methods described herein with reference to FIGS. 1-9.

The memory 1003 may store instructions for performing the polynomial multiplication method described above with reference to FIGS. 1 to 9. For example, the instructions stored in the memory 1003 may be executed by the one or more processors 1001 and, when executed by the processor 1001, may cause the operation apparatus 1000 to perform the polynomial multiplication method. For example, the instructions stored in the memory 1003, when executed by the processor 1001, may cause the operation apparatus 1000 to perform an operation of obtaining an auxiliary modulus corresponding to moduli according to the CRT, an operation of performing an NTT operation with respect to the auxiliary modulus on a result of a modulo operation of the moduli for each of a first polynomial and a second polynomial, an operation of performing an element-wise multiplication operation between an NTT operation result corresponding to the first polynomial and an NTT operation result corresponding to the second polynomial, and an operation of transforming a result of the element-wise multiplication operation into a polynomial corresponding to each of the moduli.

The operation apparatus 1000 may include the I/O device 1005. The operation apparatus 1000 may be connected to the external device (e.g., a personal computer (PC) or a network) through the I/O device 1005 and exchange data with the external device. For example, the operation apparatus 1000 may receive a polynomial to be multiplied and output the result of polynomial multiplication through the I/O device 1005.

The operation apparatus 1000 may further include other components not shown in the drawings. For example, the operation apparatus 1000 may include a communication module that provides a function for the operation apparatus 1000 to communicate with another electronic device or another server via a network. In addition, for example, the operation apparatus 1000 may further include other components such as a transceiver, various sensors, and a database.

The clients, servers, operation apparatuses, processors, memories, I/O devices, accelerators, client 110, server 120, operation apparatus 1000, processor 1001, memory 1003, I/O device 1005, and accelerator 1007 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-10 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method with a polynomial multiplication operation, the method comprising:
obtaining an auxiliary modulus corresponding to moduli according to a Chinese remainder theorem (CRT);
performing a number theoretic transform (NTT) operation with respect to the auxiliary modulus on a result of a modulo operation of the moduli for each of a first polynomial and a second polynomial;
performing an element-wise multiplication operation between an NTT operation result corresponding to the first polynomial and an NTT operation result corresponding to the second polynomial; and
transforming a result of the element-wise multiplication operation into a polynomial corresponding to each of the moduli.

2. The method of claim 1, wherein the obtaining of the auxiliary modulus comprises obtaining the auxiliary modulus, which is a Fermat number.

3. The method of claim 1, wherein a twiddle factor of an NTT operation with respect to the auxiliary modulus is determined to be a power of 2.

4. The method of claim 1, wherein the performing of the NTT operation with respect to the auxiliary modulus comprises:
transforming the result of the modulo operation of the moduli for each of the first polynomial and the second polynomial into a multivariate polynomial; and
performing an NTT operation with respect to the auxiliary modulus on a multivariate polynomial of each of the first polynomial and the second polynomial.

5. The method of claim 4, wherein
a multivariate polynomial of the first polynomial comprises a polynomial in a plurality of variables, and
degrees of the plurality of variables are less than a degree of the first polynomial.

6. The method of claim 4, wherein
a multivariate polynomial of the second polynomial comprises a polynomial in a plurality of variables, and
degrees of the plurality of variables are less than a degree of the second polynomial.

7. The method of claim 4, wherein the transforming the result of the element-wise multiplication operation into the polynomial corresponding to each of the moduli comprises:
performing an inverse number theoretic transform (INTT) operation on the result of the element-wise multiplication operation;
transforming a result of the INTT operation into a univariate polynomial; and
transforming the result of the INTT operation, which is transformed into the univariate polynomial, into a polynomial corresponding to each of the moduli.

8. The method of claim 7, wherein the result of the INTT operation is a multivariate polynomial.

9. The method of claim 1, wherein the transforming of the result of the element-wise multiplication operation into the polynomial corresponding to each of the moduli comprises:
performing an inverse number theoretic transform (INTT) operation on the result of the element-wise multiplication operation; and
transforming the result of the INTT operation into a polynomial corresponding to each of the moduli.

10. The method of claim 1, wherein the obtaining of the auxiliary modulus comprises obtaining the auxiliary modulus based on any one or any combination of any two or more of the moduli, a degree of the first polynomial, and a degree of the second polynomial.

11. The method of claim 1, further comprising:
receiving, from a client, an encrypted input, wherein the obtaining of the auxiliary modulus comprises obtaining the auxiliary modulus based on the encrypted input;
generating an encrypted prediction based on the polynomial corresponding to each of the moduli; and
transmitting, to the client, the encrypted prediction.

12. A non-transitory computer-readable storage medium storing instructions that, when executed by one or more processors, configure the one or more processors to perform the method of claim 1.

13. An apparatus with a polynomial multiplication operation, the apparatus comprising:
one or more processors configures to:
obtain an auxiliary modulus corresponding to moduli according to a Chinese remainder theorem (CRT);
perform a number theoretic transform (NTT) operation with respect to the auxiliary modulus on a result of a modulus operation of the moduli for each of a first polynomial and a second polynomial;
perform an element-wise multiplication operation between an NTT operation result corresponding to the first polynomial and an NTT operation result corresponding to the second polynomial; and
transform a result of the element-wise multiplication operation into a polynomial corresponding to each of the moduli.

14. The apparatus of claim 13, wherein the NTT operation is performed using an NTT operator corresponding to the auxiliary modulus.

15. The apparatus of claim 13, wherein, for the obtaining of the auxiliary modulus, the one or more processors are configured to obtain the auxiliary modulus, which is a Fermat number.

16. The apparatus of claim 15, wherein
a twiddle factor of the NTT operation with respect to the auxiliary modulus is determined to be a power of 2, and
a multiplication operation of the NTT operation is performed using a bit shifting operation based on the twiddle factor.

17. The apparatus of claim 13, wherein, for the performing of the NTT operation with respect to the auxiliary modulus, the one or more processors are configured to:
transform the result of the modulo operation of the moduli for each of the first polynomial and the second polynomial into a multivariate polynomial; and
perform the NTT operation with respect to the auxiliary modulus on a multivariate polynomial of each of the first polynomial and the second polynomial.

18. The apparatus of claim 17, wherein
a multivariate polynomial of the first polynomial comprises a polynomial in a plurality of variables, wherein degrees of the plurality of variables are less than a degree of the first polynomial, and
a multivariate polynomial of the second polynomial comprises a polynomial in a plurality of variables, wherein degrees of the plurality of variables are less than a degree of the second polynomial.

19. The apparatus of claim 17, wherein, for the transforming the result of the element-wise multiplication operation into the polynomial corresponding to each of the moduli, the one or more processors are configured to:
perform an inverse number theoretic transform (INTT) operation on the result of the element-wise multiplication operation;
transform a result of the INTT operation into a univariate polynomial; and
transform the result of the INTT operation, which is transformed into the univariate polynomial, into the polynomial corresponding to each of the moduli.

20. The apparatus of claim 13, wherein, for the transforming of the result of the element-wise multiplication operation into the polynomial corresponding to each of the moduli, the one or more processors are configured to:
perform an inverse number theoretic transform (INTT) operation on the result of the element-wise multiplication operation; and
transform a result of the INTT operation into the polynomial corresponding to each of the moduli.
